(19) United States
(12) Patent Application Publication
(10) Pub. No.: US 2025/0193595 A1
(43) Pub. Date: Jun. 12, 2025

(54) PROXIMITY-DEPENDENT SOUND DISTRIBUTION FOR A COMPACT AUDIO REPRODUCTION DEVICE

(71) Applicant: HARMAN INTERNATIONAL INDUSTRIES, INCORPORATED, Stamford, CT (US)

(72) Inventors: Kevin J. BASTYR, Franklin, MI (US); Christopher Michael TRESTAIN, Livonia, MI (US)

(21) Appl. No.: 18/967,918

(22) Filed: Dec. 4, 2024

Related U.S. Application Data
(60) Provisional application No. 63/607,659, filed on Dec. 8, 2023.

(51) Int. Cl. H04R 3/04; A63H 5/00; H04R 1/02; H04R 3/12

(52) U.S. Cl. CPC H04R 3/04; A63H 5/00; H04R 1/028; H04R 3/12; A63H 2200/00; H04R 2430/01

(57) ABSTRACT

Techniques for generating sound in a system that includes a compact audio reproduction device are described. In some embodiments, the techniques include determining a first distance between a first loudspeaker and the compact audio reproduction device; determining a first corner frequency for a first distance filter based on the first distance; generating a first modified audio signal for the first loudspeaker, wherein an amplitude of the first modified audio signal is based on an input audio signal and the first distance filter; and transmitting the first modified audio signal to the first loudspeaker.

### CROSS-REFERENCE TO RELATED APPLICATIONS

This application claims the benefit of U.S. Provisional patent application titled, “PROXIMITY DEPENDENT SOUND RADIATING,” filed on Dec. 8, 2023, and having Ser. No. 63/607,659. The subject matter of this related application is hereby incorporated herein by reference.

### BACKGROUND

### Field of the Various Embodiments

The contemplated embodiments relate generally to audio systems and, more specifically, to proximity-dependent sound distribution for a compact audio reproduction device.

### Description of the Related Art

Various consumer devices output sound to enhance the user experience when interacting with the consumer device. For example, various products produce sound to entertain users. In such products, a sound-producing circuit stores a pre-recorded sound file or generates in-situ the sounds to be output. When the product receives an input, such as a button press, the sound-producing circuit loads the pre-recorded sound file or generates the sound and drives a speaker to output corresponding audio. Currently, audio reproduction devices can be created with physical sizes as small as 1 or 2 cubic centimeters, thereby enabling many new audio applications. For example, compact audio devices can now be included in small interactive devices, such as an interchangeable component of an interactive toy.

At least one drawback of compact audio devices is that the compact audio devices have difficulty reproducing the timbre of many prerecorded or generated sounds. In particular, compact audio devices are oftentimes unable to generate a desirable level of low-frequency audio output. This undesirable trait can be due to the limited battery capacity and/or limited speaker back volume of compact audio devices. For example, due to battery life considerations, many compact audio devices are not operated at a full drive voltage level to avoid an undesirably short playback time. Further, due to the limited size of such devices, the speaker back volume, which is the enclosed space behind the speaker diaphragm, is inherently too small to produce sufficient bass response. As a result, compact audio devices can experience roll-off at frequencies as high as 1000 Hz, and oftentimes cannot output notes below 650 Hz, which is a full three octaves of missing bandwidth when compared to the output from larger systems. For example, conventionally sized Bluetooth speakers and sound bars commonly have audio output down to 80 Hz or lower. In the absence of the low-frequency audio output that is not producible with many compact audio devices, the sound of a V8 engine played over a compact audio device can sound more like a tiny motor scooter, while other sounds, such as the broad-spectrum sound generated by drums, can be difficult or impossible to reproduce accurately via a compact audio device.

An additional drawback of compact audio devices is that the battery life can be extremely limited. Thus, in many instances, the audio playback time for a compact audio device can be undesirably short. Further, in certain cases, to preserve a minimum audio playback time before the battery is discharged, the sound output level of a compact audio device is oftentimes limited to such a low level that high-fidelity output by the speakers contained within the compact audio device is not possible, thereby degrading the listening experience.

As the foregoing illustrates, what is needed in the art are more effective techniques for more effectively reproducing low-frequency output with compact audio devices.

### SUMMARY

One embodiment of the present disclosure sets forth a computer-implemented method that includes: determining a first distance between a first loudspeaker and a compact audio reproduction device; determining a first corner frequency for a first distance filter based on the first distance; generating a first modified audio signal for the first loudspeaker, wherein an amplitude of the first modified audio signal is based on an input audio signal and the first distance filter; and transmitting the first modified audio signal to the first loudspeaker.

At least one technical advantage of the disclosed technique relative to the prior art is that using the disclosed techniques, an audio system that includes a compact audio reproduction device can distribute audio signals to one or more satellite loudspeakers in a physical listening area in a manner that extends the frequency range of sound that is reproduced and without creating listener confusion by making the apparent location of the sound source deviate from the location of the device/object within the listening environment. In particular, the distance within a listening environment between a compact audio reproduction device and a satellite loudspeaker is determined, and an additional band-limited signal to be sent to a satellite loudspeaker is created based on the distance. By providing the additional band-limited signal to the satellite loudspeaker, for example for the generation of lower-frequency audio output, the audio system provides the audio system with an extended frequency range of audio reproduction for objects in the listening environment in real-time. Consequently, the audio system efficiently provides an increased bandwidth, more naturally reproduced sound in a listening environment that is responsive to the movements within the listening environment of an object or device that includes the compact audio reproduction device. In addition, this extended frequency range of audio reproduction can be generated without requiring large and expensive processing resources. Further, by using a technique that is compatible with a variable number of satellite loudspeakers, an audio system using the disclosed techniques can provide perceptually accurate audio within the listening environment using an arbitrary number of loudspeakers positioned within the listening environment. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1A and FIG. 1B are simplified diagrams illustrating an audio processing system in accordance with various embodiments;

FIG. 2 illustrates example distance filters for generating audio signals based on a measured distance between a satellite loudspeaker and a compact audio reproduction device;

FIG. 3 illustrates an example physical listening environment occupied by the audio processing system and loudspeakers of FIG. 1A or FIG. 1B, according to various embodiments; and

FIG. 4 sets forth a flow chart of method steps for generating audio signals based on the distance from one or more satellite loudspeakers to a tracked physical object, according to various embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

### INTRODUCTION

According to various embodiments, an audio processing system operates with an extended frequency range of audio reproduction for an object or device in the listening environment that includes a compact audio reproduction device, even as the one or more objects change location within the listening environment in real-time. In the embodiments, a distance within a listening environment between the compact audio reproduction device and a satellite loudspeaker is determined. Based on the distance and on an audio input signal representing a sound that is associated with the object or device, a modified audio signal for the satellite loudspeaker is generated and transmitted to the satellite loudspeaker. Generally, the modified audio signal is a band-limited signal, for example for the generation of lower-frequency audio output by the satellite loudspeaker that cannot be output by the compact audio reproduction device. Thus, the audio processing system uses the audio stream from the satellite loudspeaker to extend the audio play experience delivered by the compact audio reproduction device. In this way, the audio processing system produces a more immersive listening experience by providing reproduced sound that has an increased bandwidth, is more natural-sounding, and is responsive to the movements within the listening environment of an object or device that includes the compact audio reproduction device associated with the reproduced sound.

### System Overview

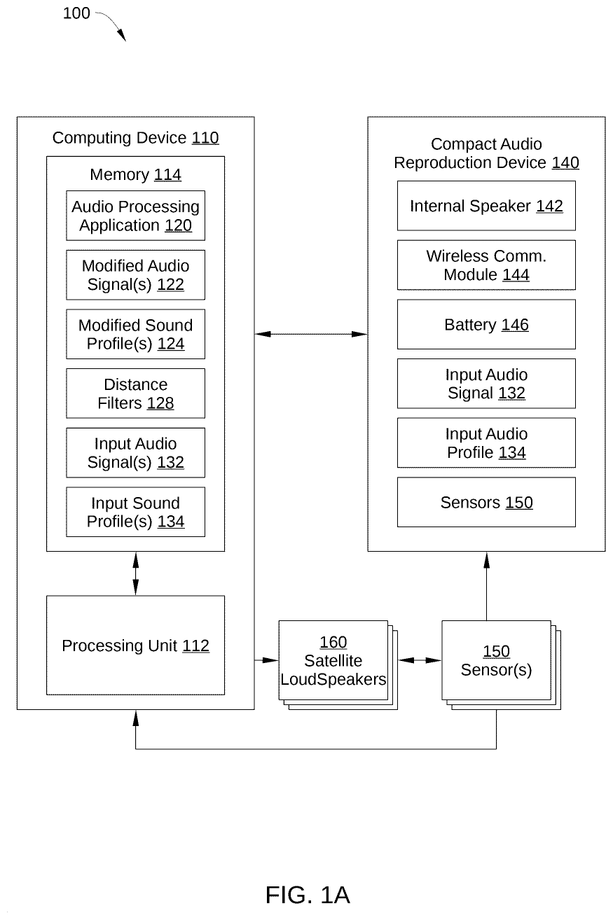

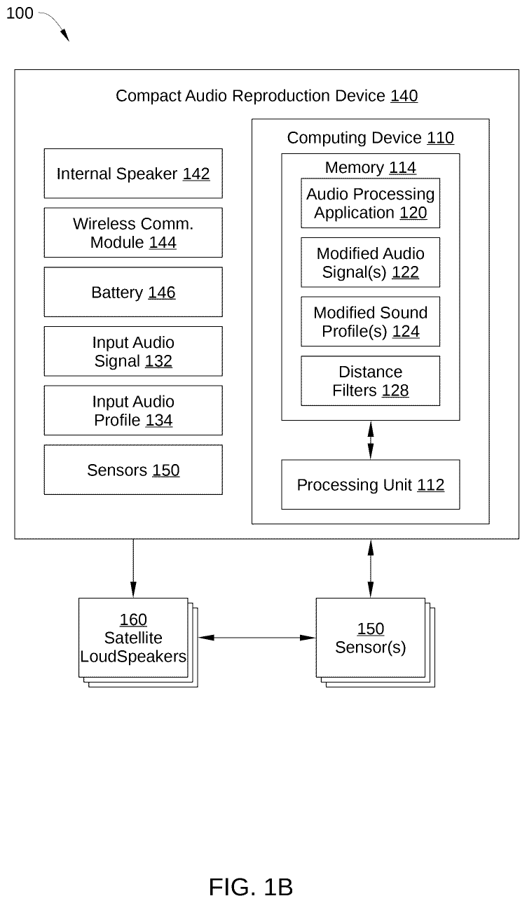

FIG. 1A and FIG. 1B are simplified diagrams illustrating an audio processing system 100 in accordance with various embodiments. As shown, audio processing system 100 includes, without limitation, a computing device 110, a compact audio reproduction device 140, one or more sensors 150, and one or more satellite loudspeakers 160. In the embodiment illustrated in FIG. 1A, computing device 110 is shown external to compact audio reproduction device 140, and in FIG. 1B, computing device 110 is shown internal to compact audio reproduction device 140.

Audio processing system 100 can be implemented in various forms, such as an interactive device including a processor and local memory, personal computers, and so forth. For example, audio processing system 100 can be incorporated in one or more interactive toys (e.g., a bird toy including a voice box). Additionally or alternatively, in some embodiments, audio processing system 100 can be incorporated into other types of non-toy consumer devices. Audio processing system 100 can perform certain processing functions using a dedicated processing device and/or a separate computing device, such as a mobile computing device of a user or a cloud computing system. Audio processing system 100 can detect various environmental values using any number of sensors of various types, which can be attached to, integrated with other system components, or disposed separately.

Compact audio reproduction device 140 operates as a sound source for an interactive toy or other object. Generally, compact audio reproduction device 140 includes, without limitation, an input audio signal 132 and an input sound profile 134. Typically, input audio signal 132 and/or input sound profile 134 can correspond to a sound effect or other sound that is nominally generated by a toy or object in which compact audio reproduction device 140 is included but is actually generated by an internal loudspeaker 142 of compact audio reproduction device 140 and/or one or more of satellite loudspeakers 160. For example, compact audio reproduction device 140 can be included in or attached to an interactive toy (e.g., an ambulance) and stores input audio signal 132 and/or input sound profile 134, either of which enables internal loudspeaker 142 to reproduce an associated sound output (e.g., a siren sound effect). In such an instance, audio processing application 120 tracks the distance between satellite loudspeakers 160 and the interactive toy within the physical listening environment and generates a set of modified audio signals for satellite loudspeakers 160 and internal loudspeaker 142 to reproduce the sounds of the interactive toy.

As shown, internal loudspeaker 142 is disposed within compact audio reproduction device 140. By contrast, satellite loudspeakers 160 are not disposed within compact audio reproduction device 140 and instead are physically separate from compact audio reproduction device 140.

In some embodiments, compact audio reproduction device 140 can be a modular and/or removable component of such an interactive toy or object. In such embodiments, one instance of compact audio reproduction device 140 can be swapped out or replaced with a different instance of compact audio reproduction device 140 and/or can be installed in a plurality of different interactive toys or objects to provide an immersive audio experience with the different interactive toys or objects. As such, compact audio reproduction device 140 can include, without limitation, an internal loudspeaker 142, a wireless communication module 144, and/or a battery 146. In some embodiments, compact audio reproduction device 140 can have a size on the order of about one or two cubic centimeters. Consequently, compact audio reproduction device 140 generally has limited battery life, and internal loudspeaker 142 generally has limited speaker back volume. As a result, in such embodiments, compact audio reproduction device 140 can be incapable of producing lower-frequency sound, and therefore experiences roll-off at frequencies as high as 1000 Hz.

Computing device 110 enables implementation of the various embodiments described herein. As such, computing device 110 generates audio signals to drive internal loudspeaker 142 and one or more satellite loudspeakers 160 to produce, in part, a sound field. Computing device 110 includes, without limitation, a processing unit 112 and a memory 114. Memory 114 stores, without limitation, an audio processing application 120, one or more modified audio signals 122, and one or more modified sound profiles 124. In embodiments in which computing device 110 is implemented to be external to compact audio reproduction device 140, as shown in FIG. 1B, computing device 110 acquires input sound profile 134 and/or input audio signal 132 from compact audio reproduction device 140 and stores input sound profile 134 and/or input audio signal 132. In such embodiments, audio processing application 120 can subsequently identify compact audio reproduction device 140 and retrieve input sound profile 134 and/or input audio signal 132 to generate a set of modified audio signals for reproduction by satellite loudspeakers 160 and internal loudspeaker 142.

In various embodiments, computing device 110 transmits a set of modified audio signals to internal loudspeaker 142 and to one or more satellite loudspeakers 160 in audio processing system 100. In various embodiments, computing device 110 can be a central unit in a home theater system, a soundbar, and/or another device that communicates with the one or more satellite loudspeakers 160, as shown in FIG. 1A. In various embodiments, computing device 110 can be included in compact audio reproduction device 140, as shown in FIG. 1B. In various embodiments, computing device 110 can be included in one or more devices, such as consumer products (e.g., interactive toys, portable speakers, gaming devices, gambling products, etc.), smart home devices (e.g., smart lighting systems, security systems, digital assistants, etc.), communications systems (e.g., conference call systems, video conferencing systems, speaker amplification systems, etc.), and so forth. In various embodiments, computing device 110 is located in various environments including, without limitation, indoor environments (e.g., living room, conference room, conference hall, home office, etc.), and/or outdoor environments, (e, patio, rooftop, garden, etc.). In some embodiments, computing device 110 is a low-power, limited processing, and/or limited memory device that implements a lightweight processing of incoming data. For example, computing device 110 can be a Raspberry Pi (e.g., Pi 1®, Pi 2 ®, Pi 3 ®, or Pi 4 ®) that includes a processor such as a digital signal processor, memory (e.g., 1-4 MB RAM), and storage (e.g., a flash storage card). For example, computing device 110 can be a development board, such as a Teensey® 4.0 microcontroller development board, or any other board that contains a processor that is used as a digital signal processor, such as an ARM® Cortex M4, or other lightweight computing devices.

Processing unit 112 can be any suitable processor, such as a central processing unit (CPU), a graphics processing unit (GPU), an application-specific integrated circuit (ASIC), a field programmable gate array (FPGA), a digital signal processor (DSP), a multicore processor, and/or any other type of processing unit, or a combination of two or more of a same type and/or different types of processing units, such as a system on a chip (SoC), or a CPU configured to operate in conjunction with a GPU. Processing unit 112 can be the onboard processor of a Raspberry Pi, Teensey or other computing device. In general, processing unit 112 can be any technically feasible hardware unit capable of processing data and/or executing software applications.

Memory 114 can include a random-access memory (RAM) module, a flash memory unit, or any other type of memory unit or combination thereof. Processing unit 112 is configured to read data from and write data to memory 114. In various embodiments, memory 114 includes non-volatile memory, such as optical drives, magnetic drives, flash drives, or other storage. In some embodiments, separate data stores, such as an external device included in a network (“cloud storage”) supplements memory 114. Audio processing application 120 within memory 114 can be executed by processing unit 112 to implement the overall functionality of computing device 110, including audio processing application 120 and/or processing incoming data from sensors 150 and, thus, to coordinate the operation of computing device 110 as a whole. Memory 114 can be the onboard memory of a Raspberry Pi, Teensey or other computing device. In various embodiments, an interconnect bus (not shown) connects processing unit 112, memory 114, and any other components of computing device 110.

Memory 114 stores input audio signal 132 and/or input sound profile 134 received from compact audio reproduction device 140. For example, in some embodiments, computing device 110 receives input sound profile 134 containing input audio signal 132 from compact audio reproduction device 140 and stores input sound profile 134 in memory 114. In some embodiments, audio processing application 120 receives input audio signal 132 separately from input sound profile 134. Additionally or alternatively, in some embodiments, computing device 110 stores one or more modified audio signals 122 that are generated based on input audio signal 132. Further, in some embodiments, memory 114 stores additional instances of input audio signal 132 and/or input sound profile 134 for one or more additional instances of compact audio reproduction device 140. In such embodiments, audio processing application 120 identifies the particular instance of compact audio reproduction device 140 and retrieves the appropriate instance of input audio signal 132 and/or input sound profile 134 that is associated with the particular instance of compact audio reproduction device 140.

Sensors 150 include various types of sensors for tracking the location of compact audio reproduction device 140 and each of satellite loudspeakers 160 within a listening environment (not shown). Additionally or alternatively, in some embodiments, sensor(s) 150 include various types of sensors for measuring a distance between compact audio reproduction device 140 and each of satellite loudspeakers 160. For example, in some embodiments, sensor(s) 150 include various types of tracking sensors, such as optical sensors, position sensors, IMUs, audio sensors, and so forth, that acquire sensor data. In embodiments in which one or more sensors 150 are disposed within compact audio reproduction device 140, compact audio reproduction device 140 sends the sensor data in one or more messages to audio processing application 120 for processing to determine the position of compact audio reproduction device 140. Similarly, in embodiments in which one or more sensors 150 are physically separate from compact audio reproduction device 140, the one or more sensors 150 send the sensor data in one or more messages to audio processing application 120 for processing to determine the position of compact audio reproduction device 140.

Sensors 150 can include various types of sensors that acquire sensor data from the physical listening environment. For example, sensors 150 can include auditory sensors, such as microphones, to receive types of sound (e.g., subsonic pulses, ultrasonic sounds, speech commands, etc.). In some embodiments, sensors 150 include optical sensors, such as RGB cameras, time-of-flight cameras, infrared cameras, depth cameras, a quick response (QR) code tracking system, potentiometers, proximity or presence sensors, motion sensors, such as an accelerometer or an inertial measurement unit (IMU) (e.g., a three-axis accelerometer, gyroscopic sensor, and/or magnetometer), pressure sensors, and so forth. In addition, in some embodiments, sensors 150 can include wireless sensors, including radio frequency (RF) sensors (e.g., sonar and radar), and/or wireless communications protocols, including Bluetooth, Bluetooth low energy (BLE), cellular protocols, and/or near-field communications (NFC).

In some embodiments, sensors 150 are proximity sensors. In such embodiments, sensors 150 can use any technically feasible distance measuring techniques including, but not limited to the use of ultrasonics, infrared light, computer imaging modalities, and/or the like. For example, in some embodiments, sensors 150 include a microphone disposed within compact audio reproduction device 140 that enables detection of inaudible audio signals generated by each satellite loudspeaker 160 to determine a distance between compact audio reproduction device 140 and each satellite loudspeaker 160. In another example, in some embodiments, sensors 150 include an ultrasonic sensor that measures a distance to a satellite loudspeaker 160 by transmitting sound waves toward the satellite loudspeaker 160 and measuring the time interval required for a portion of the transmitted sound waves to be reflected back to the ultrasonic sensor. Additionally or alternatively, in some embodiments, one or more sensors 150 are disposed within each satellite loudspeaker 160.

In some embodiments, audio processing system 100 includes other types of sensors in addition to sensors 150 to acquire information about the acoustic environment. Other types of sensors include cameras, a quick response (QR) code tracking system, motion sensors, such as an accelerometer or an inertial measurement unit (IMU) (e.g., a three-axis accelerometer, gyroscopic sensor, and/or magnetometer), pressure sensors, and so forth. In addition, in some embodiments, sensors 150 can include wireless sensors, including radio frequency (RF) sensors (e.g., sonar and radar), and/or wireless communications protocols, including Bluetooth, Bluetooth low energy (BLE), cellular protocols, and/or near-field communications (NFC).

Each of the one or more satellite loudspeakers 160 and internal loudspeaker 142 provide a sound output by reproducing a respective received audio signal. In some embodiments, the one or more satellite loudspeakers 160 can be components of a wired or wireless speaker system, or any other device that generates a sound output. By contrast, internal loudspeaker is included in compact audio reproduction device 140. In various embodiments, satellite loudspeakers 160 can be incorporated into a speaker array and/or a single device (e.g., disposed in the body of a form factor including the multiple loudspeakers) and share a common location. In various embodiments, satellite loudspeakers 160 are implemented using any number of different conventional form factors, such as a single consumer product, discrete loudspeaker devices, personal speakers, body-worn (head, shoulder, arm, etc.) speaker devices, and so forth. In some embodiments, satellite loudspeakers 160 can be connected to output devices that additionally provide other forms of outputs, such as display devices that provide visual outputs.

Each of the one or more satellite loudspeakers 160 and internal loudspeaker 142 of audio processing system 100 can be any technically feasible type of audio outputting device. For example, in some embodiments, each satellite loudspeaker 160 and/or internal loudspeaker 142 includes one or more digital speakers that receive an audio signal in a digital form and convert the audio output signals into air-pressure variations or sound energy via a transducing process. According to various embodiments, each of the plurality of satellite loudspeakers 160 generates sound output for compact audio reproduction device 140 based on a modified audio signal 122 received from audio processing application 120. Similarly, internal loudspeaker 142 generates sound output for compact audio reproduction device 140 based on input audio signal 132 received from audio processing application 120.

In operation, audio processing application 120 determines the relative distance of compact audio reproduction device 140 to one or more satellite loudspeakers 160 and generates audio signals for at least one satellite loudspeaker 160 and/or internal loudspeaker 142 to reproduce. Specifically, audio processing application 120 generates input audio signal 132 for internal loudspeaker 142 and at least one modified audio signal 122 for at least one satellite loudspeaker 160 to reproduce. In some embodiments, audio processing application 120 generates a modified audio signal 122 and an input audio signal 132 by first determining the distance between compact audio reproduction device 140 and each satellite loudspeaker 160. The audio processing application 120 then uses the respective computed distance for each satellite loudspeaker 160 to generate a set of modified audio signals that are adjusted as a function of at least the computed distances. Audio processing application 120 then transmits input audio signal 132 to compact audio reproduction device 140 for reproduction by internal loudspeaker 142 and a respective modified audio signal 122 to each satellite loudspeaker 160 for reproduction.

In various embodiments, audio processing application 120 determines the current distance between compact audio reproduction device 140 and each satellite loudspeaker 160 within a physical listening environment. Additionally or alternatively, audio processing application 120 tracks these distances as either compact audio reproduction device 140 or a satellite loudspeaker 160 moves. For example, in some instances, audio processing application 120 receives sensor data from the one or more sensors 150. In such instances, the sensor data may include distance data for a given satellite loudspeaker 160, such as a series of optical data, and/or a series of auditory data received in response to test signals generated by computing device 110. In such instances, the sensor data can indicate the distance between compact audio reproduction device 140 and each satellite loudspeaker 160 at a given time, and audio processing application 120 processes the sensor data to determine the distance between compact audio reproduction device 140 and each satellite loudspeaker 160. In some embodiments, the sensor data indicates that at least one satellite loudspeaker 160 or compact audio reproduction device 140 is moving. In embodiments in which one or more sensors 150 are disposed within a satellite loudspeaker 160, the satellite loudspeaker 160 can acquire sensor data while moving and transmit a sequence of messages containing the acquired sensor data. In such embodiments, audio processing application 120 can receive and aggregate the sensor data included in the sequence of messages and determine the trajectory and/or current position of the satellite loudspeaker 160.

### Sound Distribution for a Compact Audio Reproduction Device Using Distance Filters

In various embodiments, audio processing application 120 generates audio signals for internal loudspeakers 142 and satellite loudspeakers 160 based on a set of computed distances and one or more distance filters. In various embodiments, audio processing application 120 uses one or more distance filters to modify the amplitude and/or phase of an input audio signal 132 to generate a different modified audio signal 122 for one or more satellite loudspeakers 160 based on the respective computed distance between each satellite loudspeaker 160 and compact audio reproduction device 140. Additionally or alternatively, in some embodiments, audio processing application 120 uses other functions to modify input audio signal 132 based on the orientation of one or more satellite loudspeakers 160 relative to compact audio reproduction device 140.

In various embodiments, audio processing application 120 selects a distance filter 128 from a set of candidate distance filters 128. For example, computing device 110 can store a set of candidate distance filters 128, such as a low pass filter, a high pass filter, a second or higher order low pass filter, a second or higher order high pass filter, and/or a bandpass filter. In the embodiments, the selected distance filter 128 attenuates the gain and/or changes the phase of the input audio signal 132 as a function of the distance between compact audio reproduction device 140 and a particular satellite loudspeaker 160. In such instances, audio processing application 120 uses the selected distance filter 128 to modify the amplitude and/or phase of an input audio signal 132 for the given satellite loudspeaker 160 and internal loudspeaker 142 based on the computed distances between the given satellite loudspeaker 160 and compact audio reproduction device 140. In this way, audio processing application 120 uses the selected distance filter 128 to generate a respective modified audio signal 122 for each satellite loudspeaker 160 and a separate modified audio signal 122 for internal loudspeaker 142.

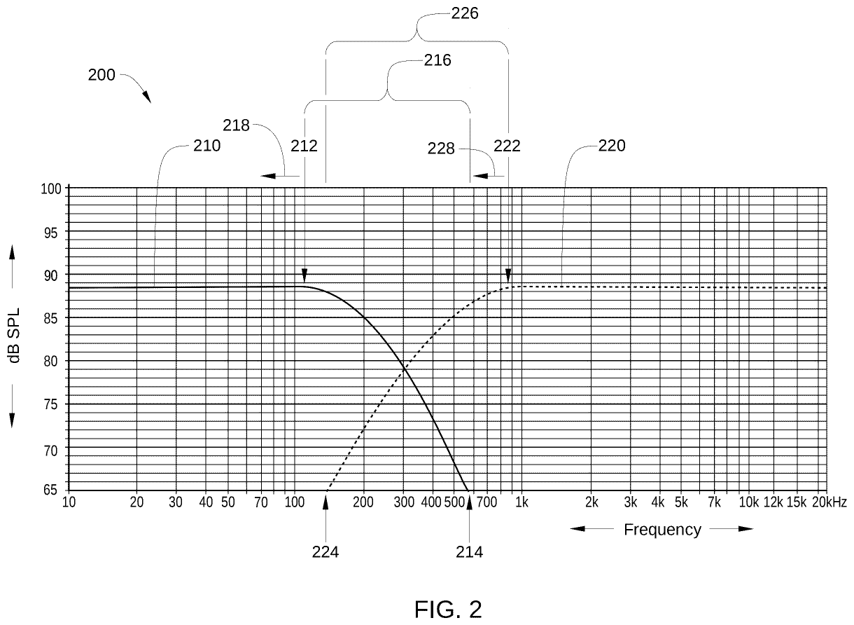

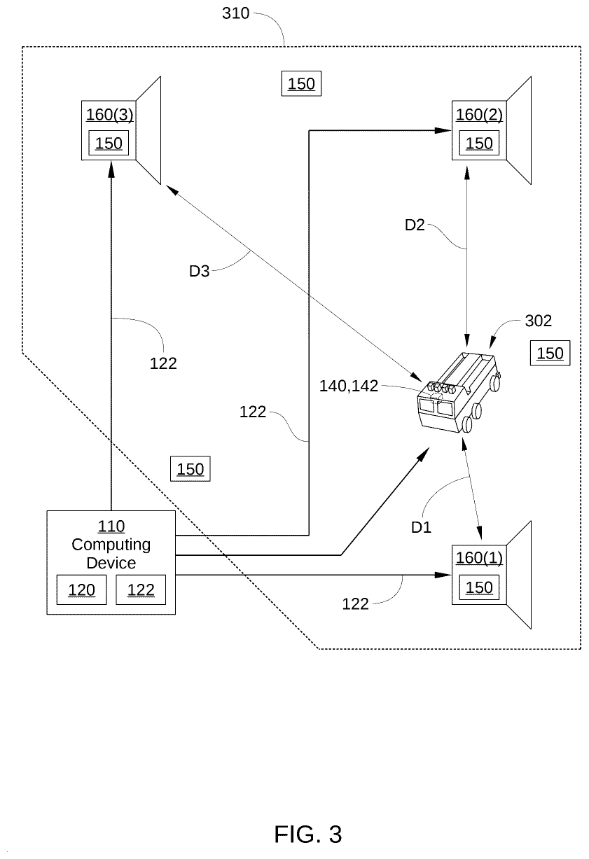

In some embodiments, to generate a particular modified audio signal 122, audio processing application 120 uses a distance filter that includes a combination of two filters. In such embodiments, the first of these filters attenuates the amplitude of a high-frequency portion of an input audio signal 132, and the resultant modified audio signal 122 is sent to a satellite loudspeaker 160. Conversely, the second of these filters attenuates the amplitude of a low-frequency portion of the input audio signal 132, and the resultant modified audio signal 122 is sent to internal loudspeaker 142. Various example embodiments of distance filter 128 are described below in conjunction with FIGS. 2 and 3.

FIG. 2 illustrates example distance filters 200 for generating audio signals based on a measured distance between a satellite loudspeaker 160 and compact audio reproduction device 140. In the embodiment illustrated in FIG. 2, distance filters 200 includes a low-pass filter 210 and a high-pass filter 220 (dashed lines). Low-pass filter 210 indicates the portion of the audio spectrum of input audio signal 132 that is included in a modified audio signal 122 that is transmitted to a satellite loudspeaker 160, while high-pass filter 220 indicates the portion of the audio spectrum of input audio signal 132 that is included in a modified audio signal 122 that is transmitted to internal loudspeaker 142.

As shown, low-pass filter 210 includes a corner frequency 212 at which frequencies of input audio signal 132 begin to fall off to a value of zero amplitude at a maximum threshold frequency 214, and high-pass filter 220 includes a corner frequency 222 at which frequencies of input audio signal 132 begin to fall off to a value of zero amplitude at a minimum threshold frequency 224. Thus, low-pass filter 210 includes a fall-off region 216 that corresponds to the portion of the audio spectrum of input audio signal 132 between corner frequency 212 and maximum threshold frequency 214, while high-pass filter 220 includes a fall-off region 226 that corresponds to the portion of the audio spectrum of input audio signal 132 between corner frequency 222 and minimum threshold frequency 224. In the embodiment illustrated in FIG. 2, fall-off region 216 of low-pass filter 210 overlaps with fall-off region 226 of high-pass filter 220. In other embodiments, fall-off region 216 overlaps with fall-off region 226 to a lesser extent than that shown in FIG. 2. Alternatively, in some embodiments, fall-off region 216 overlaps with fall-off region 226 to a greater extent than that shown in FIG. 2. For example, in such embodiments, fall-off region 216 and fall-off region 226 can each cover an identical portion of the audio spectrum of an input audio signal 132.

In the embodiment illustrated in FIG. 2, distance filters 200 can be employed to generate a first modified audio signal 122 for internal loudspeaker 142 and a second modified audio signal 122 for at least one of satellite loudspeakers 160. Thus, in the embodiment, the output audio stream associated with input audio signal 132 can be split between two or more loudspeakers, where a loudspeaker that can more effectively reproduce lower-frequency sound output (e.g., one or more satellite loudspeakers 160) receives the lower-frequency portion of input audio signal 132, while internal loudspeaker 142 receives the higher-frequency portion of input audio signal 132. As a result, one or more satellite loudspeakers 160 of audio processing system 100 reproduce the portions of the audio spectrum of input audio signal 132 that cannot be reproduced by internal loudspeaker 142, thereby significantly enhancing the quality of sound delivered to a listener. In addition, while the overall level of audio output may increase slightly when distance filters 200 process input audio signal 132 in this way, the psychoacoustic loudness of the audio output by audio processing system 100 does not increase proportionately, due to the perceptual low loudness weighting of frequencies below 200 Hz. For example, the Fletcher-Munson curves indicate that the perceived loudness of such low frequencies is much lower than an equal sound-pressure level (SPL) of 1-3 kHz. Consequently, the result of bringing an interactive toy or other object containing compact audio reproduction device 140 within a threshold distance of a satellite loudspeaker 160 that causes audio processing application 120 to employ distance filters 200 is an increase in fullness of the sound produced by audio processing system 100 without a dramatic increase in loudness of the sound.

In the embodiment illustrated in FIG. 2, corner frequency 212 of low-pass filter 210 is a different frequency than corner frequency 222 of high-pass filter 220. In other embodiments, corner frequency 212 of low-pass filter 210 can be identical to corner frequency 222 of high-pass filter 220. In such embodiments, the combined output of internal loudspeaker 142 and the one or more satellite loudspeakers 160 reproduces frequencies across substantially the entire audio band, without a frequency gap where no loudspeaker emits audio with high amplitude.

In some embodiments, low-pass filter 210 and/or high-pass filter 220 are first-order filters. In other embodiments, distance filters 200 include higher-order filters, such as second-order filters, third-order filters, fourth-order filters, and/or or even higher-order filters. These second-order and higher-order filters can result in a more abrupt transition between the passband and the stop band of low-pass filter 210 and/or high-pass filter 220. In some embodiments, the characteristics of low-pass filter 210 and/or high-pass filter 220 can be predetermined and employed in the form of a look-up table that is based on a measured distance between compact audio reproduction device 140 and a satellite loudspeaker 160. Thus, in such embodiments, low-pass filter 210 and/or high-pass filter 220 can be selected from such a look-up table.

In some embodiments, corner frequency 212 of a low-pass filter 210 and corner frequency 222 of high-pass filter 220 are each determined based on a measured distance between compact audio reproduction device 140 and the satellite loudspeaker 160 that is associated with low-pass filter 210. Therefore, in such embodiments, corner frequency 212 and corner frequency 222 vary depending on the measured distance. For example, as the measured distance between compact audio reproduction device 140 and a satellite loudspeaker 160 increases, corner frequency 212 of low-pass filter 210 decreases to a lower frequency, as indicated by arrow 218. As a result, a lower-frequency portion of the audio spectrum of input audio signal 132 is employed to generate the modified audio signal 122 that is transmitted to the satellite loudspeaker 160. Similarly, as the measured distance between compact audio reproduction device 140 and a satellite loudspeaker 160 increases, corner frequency 222 of high-pass filter 220 decreases to a lower frequency, as indicated by arrow 228. As a result, more of a higher-frequency portion of the audio spectrum of input audio signal 132 is employed to generate the modified audio signal 122 that is transmitted to internal loudspeaker 142. Conversely, as the measured distance between compact audio reproduction device 140 and a satellite loudspeaker 160 decreases, corner frequency 212 of low-pass filter 210 increases to a higher frequency. As a result, a larger low-frequency portion of the audio spectrum of input audio signal 132 is employed to generate the modified audio signal 122 that is transmitted to the satellite loudspeaker 160. Similarly, as the measured distance between compact audio reproduction device 140 and a satellite loudspeaker 160 decreases, corner frequency 222 of high-pass filter 220 increases to a lower frequency, as indicated by arrow 228. As a result, a smaller a high-frequency portion of the audio spectrum of input audio signal 132 is employed to generate the modified audio signal 122 that is transmitted to internal loudspeaker 142.

In the embodiment illustrated in FIG. 2, certain frequencies are depicted for cut-off frequency 214 and cut-off frequency 224. Such frequencies are illustrated as examples. In practice, any technically feasible frequencies for cut-off frequency 214 and cut-off frequency 224 can be implemented in distance filters 200. Further, cut-off frequency 214 and/or cut-off frequency 224 can vary as a function of the measured distance. For example, in some embodiments, cut-off frequency 214 can vary between 1 kHz and 7 kHz and cut-off frequency 224 can vary between 100 Hz and 1 kHz.

In the embodiment illustrated in FIG. 2, distance filters 200 are implemented as a set of two filters. In embodiments in which audio processing system includes three or more satellite loudspeakers, distance filter 200 can be implemented as a set of three or more filters, where one filter corresponds to internal loudspeaker 142, and one respective filter corresponds to each of the different satellite loudspeakers 160. Further, in embodiment in which more than one satellite loudspeaker 160 is included in audio processing system 100, the amplitude of distance filters 200 can be further modified to account for two or more satellite loudspeakers 160 playing sound. That is, when two (or more) satellite loudspeakers 160 radiate sound to reinforce internal loudspeaker 142, the level of the low-frequency sound from the two or more satellite loudspeakers 160 can be louder than the output from internal loudspeaker 142 if each filter included in distance filters 200 has identical amplitude. Therefore, in an embodiment, when two (or more) satellite loudspeakers 160 are included in audio processing system 100, the amplitude of the distance filter for each satellite loudspeaker 160 can be reduced by an amplitude that may be for example, 6 dB. Other reductions in amplitude are possible, such as 3 dB, or still other values.

In some embodiments, the above-described filters can also modify the amplitude of input audio signal 132 outside minimum and maximum thresholds. Though the term used herein is “distance filter,” it is understood that this term can refer to a pair of filters, one for attenuating a high-frequency portion of input audio signal 132 and one for attenuating a low-frequency portion of input audio signal 132.

In various embodiments, audio processing application 120 drives computing device 110 to transmit a set of modified audio signals 122 to the one or more satellite loudspeakers 160 of audio processing system 100. In some embodiments, each of the respective satellite loudspeakers 160 receives a corresponding modified audio signal 122 from computing device 110 via a wire, a wireless stream, or via a network. Upon receipt of the corresponding modified audio signal 122, each satellite loudspeaker 160 reproduces a respective audio output (e.g., generates soundwaves) within the physical listening environment based on the corresponding modified audio signal 122. In various embodiments, the audio output (soundwaves) produced by the one or more satellite loudspeakers 160 and internal loudspeaker 142 combine to generate a sound field that provides a perceptually accurate location of compact audio reproduction device 140 within the physical listening environment, or an object or device that is disposed within the physical listening environment and includes compact audio reproduction device 140.

FIG. 3 illustrates an example physical listening environment 310 occupied by audio processing system 100 and satellite loudspeakers 160 of FIG. 1A or FIG. 1B, according to various embodiments. As shown, physical listening environment 310 includes, without limitation, a set of multiple satellite loudspeakers 160(1), 160(2), and 160(3) (referred to collectively herein as satellite loudspeakers 160), one or more sensors 150, and a physical object 302. Physical object 302 can be an interactive toy, device, or other object that is disposed within physical listening environment 310 and includes compact audio reproduction device 140.

Physical listening environment 310 can be a portion of a real-world environment that includes one or more satellite loudspeakers 160. In various embodiments, physical listening environment 310 can include any technically feasible number of satellite loudspeakers 160. In such embodiments, audio processing application 120 computes the distance between physical object 302 and each of satellite loudspeakers 160 and distributes a respective modified audio signal 122 to each of satellite loudspeakers 160 and internal loudspeaker 142.

In the embodiment illustrated in FIG. 3, one or more sensors 150 are disposed within each satellite loudspeaker 160 and within physical listening environment 310. As noted above, in some embodiments, one or more sensors 150 can also be disposed within physical object 302. Alternatively, in some embodiments, sensors may be disposed within physical listening environment 310 and not within satellite loudspeakers 160. Alternatively, in some embodiments, sensors may be disposed within satellite loudspeakers 160 and not in physical listening environment 310.

In operation, audio processing application 120 determines the respective distances between each satellite loudspeaker 160 and physical object 302 in physical listening environment 310. For example, in some embodiments, audio processing application determines a distance D1 between physical object 302 and satellite loudspeaker 160(1), a distance D2 between physical object 302 and satellite loudspeaker 160(2), and a distance D3 between physical object 302 and satellite loudspeaker 160(3). As described above, audio processing application 120 employs a suitable distance filters 200 to generate a respective modified audio signal 122 for each of satellite loudspeakers 160 and input loudspeaker 142, where distance filters 200 are selected based on distance D1, distance D2, and distance D3. Thus, audio processing application 120 generates modified audio signal 122 for satellite loudspeaker 160(1) using distance filters 200 to modify the amplitude and/or phase of input audio signal 132 as a function of distance D1, generates modified audio signal 122 for satellite loudspeaker 160(2) using distance filters 200 to modify the amplitude and/or phase of input audio signal 132 as a function of distance D2, and generates modified audio signal 122 for satellite loudspeaker 160(3) using distance filters 200 to modify the amplitude and/or phase of input audio signal 132 as a function of distance D3. In this manner, audio processing application 120 drives satellite loudspeakers 160 and internal loudspeaker 142 to produce, in real-time, a sound field that is wider in frequency range than the sound field that internal loudspeaker 142 can produce alone. Further, according to the embodiments described herein, satellite loudspeakers 160 and internal loudspeaker 142 can generate a sound field that provides a perceptually accurate representation of the position of physical object 302 within physical listening environment 310. In such embodiments, the sound field is perceptually unaffected by the portion of the sound field originating from more physically distant satellite loudspeakers 160, and provides to the listener the impression that all the sound emanates from physical object 302.

In various embodiments, audio processing application 120 adjusts for the movement of one or more of satellite loudspeakers 160 within physical listening environment 310. In such embodiments, audio processing application 120 receives from the one or more sensors 150 sensor data indicating the distance between physical object 302 and each satellite loudspeaker 160 at a particular time. In some embodiments, the sensor data indicates that at least one of satellite loudspeakers is moving. In one example, audio processing application 120 acquires sensor data in the form of tracking data that includes a series of optical data acquired by optical sensors, and/or a series of auditory data received by one or more microphones in response to test signals generated by computing device 110. In such embodiments, audio processing application 120 processes the tracking data to determine the current distance of each satellite loudspeaker 160 from physical object 302. Additionally or alternatively, in some embodiments, audio processing application 120 receives sensor data generated by position sensors and/or an IMU (e.g., acceleration measurements, magnetic field measurements, angular rates, etc.) disposed on a particular satellite loudspeaker 160. For example, satellite loudspeaker 160(1) transmits a sequence of messages containing the sensor data while moving within physical listening environment 310. In such instances, audio processing application 120 receives and aggregates the sensor data included in the messages and determines the trajectory and/or current distance D1 of that particular satellite loudspeaker 160.

### Procedure for Proximity-Dependent Sound Distribution for a Compact Audio Reproduction Device

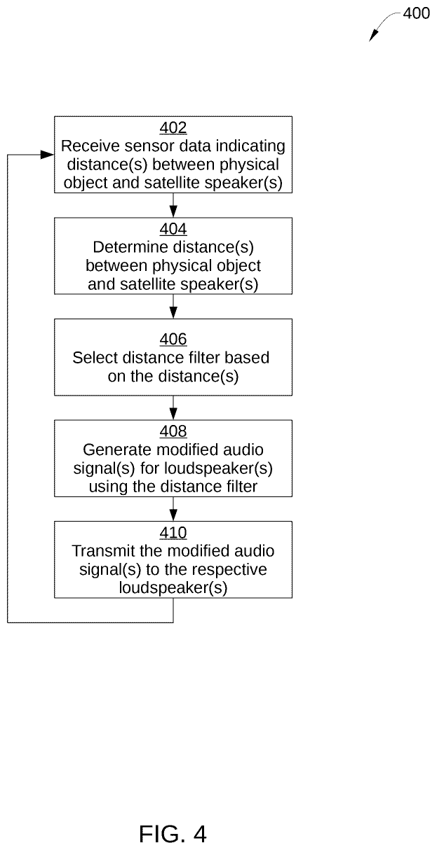

FIG. 4 sets forth a flow chart of method steps for generating audio signals based on the distance from satellite loudspeakers 160 to tracked physical object 302, according to various embodiments. Although the method steps are described with reference to the systems of FIGS. 1A-3, persons skilled in the art will understand that any system configured to implement the method steps, in any order, falls within the scope of the present disclosure.

As shown, a method 400 begins at step 402, where audio processing application 120 receives sensor data indicative of the distance between physical object 302 and one or more satellite loudspeakers 160. In various embodiments, audio processing application 120 executing on computing device 110 tracks the distance between physical object 302 and each satellite loudspeaker 160 within a physical listening environment 310. In various embodiments, audio processing application 120 receives sensor data from one or more sensors 150 coupled to computing device 110, where the sensor data indicates the distance between physical object 302 and each satellite loudspeaker 160 at a given time. In some embodiments, the sensor data indicates that at least one satellite loudspeaker 160 is moving. In some embodiments, the sensor data indicates that at least one physical object (e.g., physical object 302) among multiple tracked physical objects is moving. In one example, audio processing application 120 acquires sensor data from the one or more sensors 150 coupled to the computing device 110 (e.g., tracking data for a given satellite loudspeaker 160 as a series of optical data, and/or a series of auditory data received in response to test signals generated by computing device 110). Additionally or alternatively, in some embodiments, audio processing application 120 receives sensor data generated by position sensors and/or an IMU (e.g., acceleration measurements, magnetic field measurements, angular rates, etc.) disposed on a satellite loudspeaker 160.

At step 404, computing device 110 determines the current distances between physical object 302 and each satellite loudspeaker 160 of the set of satellite loudspeakers 160. In some embodiments, computing device 110 determines the current distances from the sensor data. Additionally or alternatively, in some embodiments, audio processing application 120 performs additional processing required to compute the distances from the tracked physical object 302 to the one or more satellite loudspeakers 160. In some embodiments, audio processing application 120 uses signal processing steps to convert pulses into a distance or converts sensor output voltage into a distance. In various embodiments, audio processing application 120 computes a set of distances between the position of each satellite loudspeaker 160 and the tracked physical object 302. In some embodiments, audio processing application 120 computes physical distances (e, Euclidean distances) from physical object 302 to each satellite loudspeaker 160 in physical listening environment 310 to determine distances D1, D2, and/or D3.

At step 406, audio processing application 120 selects distance filters 200. In various embodiments, audio processing application 120 selects distance filters 200 from a set of candidate distance filters to use when generating a set of audio signals for the set of satellite loudspeakers 160 and internal loudspeaker 142. In various embodiments, audio processing application 120 applies the computed distance for a particular satellite loudspeaker 160 using distance filters 200 to modify the amplitude and/or phase of input audio signal 132 when generating a modified audio signal 122 for that particular satellite loudspeaker 160 or internal loudspeaker 142 to reproduce. For example, computing device 110 can store a set of candidate distance filters 200, such as first-order high-pass filters, first-order low-pass filters, higher-order high- or low-pass filters, etc. that each attenuate the gain and/or change the phase of input audio signal 132 as a function of the distance between tracked physical object 302 and a particular satellite loudspeaker 160.

At step 408, audio processing application 120 generates a different modified audio signal 122 for each satellite loudspeaker 160 and internal loudspeaker 142 based on the measured or computed distances D1, D2, and/or D3 and on the selected distance filters 200. In various embodiments, audio processing application 120 uses selected distance filters 200 to modify the amplitude and/or phase of input audio signal 132 for each satellite loudspeaker 160 and internal loudspeaker 142 based on the respective computed distances D1, D2, and/or D3 between satellite loudspeakers 160 and tracked physical object 302.

In various embodiments, based on input audio signal 132, audio processing application 120 generates a set of modified audio signals 122 that includes a different modified audio signal 122 for each satellite loudspeaker 160 and internal loudspeaker 142. In the embodiments, audio processing application 120 generates the modified audio signals by modifying input audio signal 132 using the selected distance filters 200. For example, audio processing application 120 generates a modified audio signal for a satellite loudspeaker 160 by modifying the amplitude of input audio signal 132 using the selected distance filters 200. In an embodiment, distance filters 200 modify the amplitude of input audio signal 132 as a function of a suitable measured or computed distance (e.g., distance D1, D2, or D3) such that the bandwidth of a modified audio signal 122 decreases as the measured or computed distance increases. In some embodiments, distance filters 200 modify the amplitude of input audio signal 132 as a function of the measured or computed distance such that the corner frequency of the modified audio signal 122 decreases as the measured or computed distance increases.

In some embodiments, distance filters 200 are applied to input audio signal 132 between a minimum distance and a maximum distance. In such instances, audio processing application 120 compares the measured or computed distance to a minimum distance threshold and/or to a maximum distance threshold. When audio processing application 120 determines that the measured or computed distance satisfies the threshold(s), audio processing application 120 applies the selected distance filters 200. Thus, in such embodiments, when a particular satellite loudspeaker 160 moves beyond a certain maximum distance threshold, no modified audio signal 122 is generated for or transmitted to that particular satellite loudspeaker 160. Additionally or alternatively, in such embodiments, when a particular satellite loudspeaker 160 moves within a certain minimum distance threshold (and therefore is located proximate to physical object 302), no modified audio signal 122 is generated for internal loudspeaker 142. Instead, a modified audio signal 122 is generated for that particular satellite loudspeaker 160 that includes most or all of the audio spectrum of input audio signal 132 and no modified audio signal 122 is generated for internal loudspeaker 142. Thus, in such embodiments, when a particular satellite loudspeaker 160 moves close to physical object 302, that particular satellite loudspeaker 160 reproduces sound associated with physical object 302 instead of internal loudspeaker 142.

At step 410, audio processing application 120 transmits the modified audio signals to one or more satellite loudspeakers 160. In various embodiments, audio processing application 120 drives computing device 110 to transmit the set of modified audio signals to the one or more satellite loudspeakers 160 and to internal loudspeaker 142. In some embodiments, each satellite loudspeaker 160 and internal loudspeaker 142 receives a different modified audio signals 122 from computing device 110 via a wire, a wireless stream, or via a network. Upon receipt of modified audio signals 122, each satellite loudspeaker 160 and internal loudspeaker 142 reproduces a respective modified audio signal 122 to generate soundwaves within physical listening environment 310. In various embodiments, the soundwaves that the set of satellite loudspeakers 160 and internal loudspeaker 142 generate combine to generate a sound field that provides a perceptually accurate location of physical object 302 within physical listening environment 310.

Upon transmitting the audio signals to the set of satellite loudspeakers 160, audio processing application 120 returns to step 402 to optionally track any additional movement by physical object 302 and/or the one or more satellite loudspeaker 160 of audio processing system 100. For example, audio processing application 120 returns to step 402 to detect movement of one or more satellite loudspeakers 160 to a new location within physical listening environment 310, which indicates that there is a new distance from the moving satellite loudspeaker 160 to physical object 302. In such instances, audio processing application 120 repeats at least a portion of method 400 to compute and/or measure the distance between physical object 302 and the satellite loudspeaker 160 at the new location.

In sum, an audio processing application determines, for each satellite loudspeaker of an audio processing system, a distance between the location of a compact audio reproduction device and the location of the satellite loudspeaker. Upon determining the distances, the audio processing application then generates modified audio signals for each satellite loudspeaker based on the respective measured or computed distance for that satellite loudspeaker. When generating the modified audio signals, audio processing application determines the high, low, or bandpass filter of a given audio signal for the loudspeaker based on the determined distance. Audio processing application then distributes the modified audio signals to the respective satellite loudspeakers and an internal loudspeaker of the compact audio reproduction device for reproduction in the physical listening environment.

At least one technical advantage of the disclosed technique relative to the prior art is that using the disclosed techniques, an audio system that includes a compact audio reproduction device can distribute audio signals to one or more satellite loudspeakers in a physical listening area in a manner that extends the frequency range of sound that is reproduced and without creating listener confusion by making the apparent location of the sound source deviate from the location of the device/object within the listening environment. In particular, the distance within a listening environment between a compact audio reproduction device and a satellite loudspeaker is determined, and an additional band-limited signal to be sent to a satellite loudspeaker is created based on the distance. By providing the additional band-limited signal to the satellite loudspeaker, for example for the generation of lower-frequency audio output, the audio system provides the audio system with an extended frequency range of audio reproduction for objects in the listening environment in real-time. Consequently, the audio system efficiently provides an increased bandwidth, more naturally reproduced sound in a listening environment that is responsive to the movements within the listening environment of an object or device that includes the compact audio reproduction device. In addition, this extended frequency range of audio reproduction can be generated without requiring large and expensive processing resources. Further, by using a technique that is compatible with a variable number of satellite loudspeakers, an audio system using the disclosed techniques can provide perceptually accurate audio within the listening environment using an arbitrary number of loudspeakers positioned within the listening environment. These technical advantages provide one or more technological improvements over prior art approaches.

Aspects of the disclosure are also described according to the following clauses.
1. In some embodiments, a computer-implemented method of generating sound in a system that includes a compact audio reproduction device includes: determining a first distance between a first loudspeaker and the compact audio reproduction device; determining a first corner frequency for a first distance filter based on the first distance; generating a first modified audio signal for the first loudspeaker, wherein an amplitude of the first modified audio signal is based on an input audio signal and the first distance filter; and transmitting the first modified audio signal to the first loudspeaker.
2. The computer-implemented method of clause 1, further comprising: determining a second corner frequency for a second distance filter based on the first distance; and generating a second modified audio signal for a second loudspeaker, wherein an amplitude of the second modified audio signal is based on the input audio signal and the second distance filter.
3. The computer-implemented method of clauses 1 or 2, wherein the second loudspeaker is disposed within the compact audio reproduction device.
4. The computer-implemented method of any of clauses 1-3, wherein the first loudspeaker is external to the compact audio reproduction device.
5. The computer-implemented method of any of clauses 1-4, further comprising: determining that the first distance between the first loudspeaker and the compact audio reproduction device has changed from a first distance value to a second distance value; determining a second corner frequency for the first distance filter based on the second distance value of the first distance; generating a second modified audio signal for the first loudspeaker, wherein an amplitude of the second modified audio signal is based on the input audio signal, the first distance filter, and the second corner frequency; and transmitting the second modified audio signal to the first loudspeaker.
6. The computer-implemented method of any of clauses 1-5, wherein, when the second distance value is greater than the first distance value, the second corner frequency is lower than the first corner frequency.
7. The computer-implemented method of any of clauses 1-6, further comprising: determining that the first distance between the first loudspeaker and the compact audio reproduction device exceeds a threshold distance value; and transmitting no audio signal to the first loudspeaker.
8. The computer-implemented method of any of clauses 1-7, further comprising: determining that the first distance between the first loudspeaker and the compact audio reproduction device is less than a threshold distance value; and transmitting no audio signal to a second loudspeaker that is disposed within the compact audio reproduction device.
9. The computer-implemented method of any of clauses 1-8, wherein the compact audio reproduction device comprises a component of an interactive toy.
10. The computer-implemented method of any of clauses 1-9, wherein the component comprises at least one of a modular component of the interactive toy or a removable component of the interactive toy.
11. The computer-implemented method of any of clauses 1-10, wherein determining the first distance comprises tracking the first loudspeaker via one or more distance sensors.
12. The computer-implemented method of any of clauses 1-11, wherein at least one of the one or more distance sensors is disposed within a compact audio reproduction device.
13. The computer-implemented method of any of clauses 1-12, wherein at least one of the one or more distance sensors is disposed within the first loudspeaker.
14. In some embodiments, one or more non-transitory computer-readable media store instructions that, when executed by one or more processors, cause the one or more processors to perform the steps of: determining a first distance between a first loudspeaker and a compact audio reproduction device; determining a first corner frequency for a first distance filter based on the first distance; generating a first modified audio signal for the first loudspeaker, wherein an amplitude of the first modified audio signal is based on an input audio signal and the first distance filter; and transmitting the first modified audio signal to the first loudspeaker.
15. The non-transitory computer-readable media of clause 14, storing further instructions that, when executed by one or more processors, cause the one or more processors to perform the steps of: determining a second corner frequency for a second distance filter based on the first distance; and generating a second modified audio signal for a second loudspeaker, wherein an amplitude of the second modified audio signal is based on the input audio signal and the second distance filter.
16. The non-transitory computer-readable media of clauses 14 or 15, storing further instructions that, when executed by one or more processors, cause the one or more processors to perform the steps of: determining that the first distance between the first loudspeaker and the compact audio reproduction device has changed from a first distance value to a second distance value; determining a second corner frequency for the first distance filter based on the second distance value of the first distance; generating a second modified audio signal for the first loudspeaker, wherein an amplitude of the second modified audio signal is based on the input audio signal, the first distance filter, and the second corner frequency; and transmitting the second modified audio signal to the first loudspeaker.
17. The non-transitory computer-readable media of any of clauses 14-16, storing further instructions that, when executed by one or more processors, cause the one or more processors to perform the steps of: determining a second distance between a second loudspeaker and the compact audio reproduction device; determining a second corner frequency for a second distance filter based on the second distance; generating a second modified audio signal for the second loudspeaker, wherein an amplitude of the second modified audio signal is based on the input audio signal and the second distance filter; and transmitting the second modified audio signal to the second loudspeaker.
18. The non-transitory computer-readable media of any of clauses 14-17, wherein transmitting the second modified audio signal to the second loudspeaker comprises halting the transmitting of the first modified audio signal to the first loudspeaker.
19. In some embodiments includes, an interactive toy that generates an audio output includes: at least one sensor that acquires sensor data; an internal loudspeaker; a memory storing instructions; and one or more processors, that when executing the instructions, are configured to perform the steps of: determining a first distance between a first satellite loudspeaker and the interactive toy; determining a first corner frequency for a first distance filter based on the first distance; generating a first modified audio signal for the first satellite loudspeaker, wherein an amplitude of the first modified audio signal is based on an input audio signal and the first distance filter; and transmitting the first modified audio signal to the first satellite loudspeaker.
20. The interactive toy of clause 19, further comprising: determining a second corner frequency for a second distance filter based on the first distance; and generating a second modified audio signal for a second loudspeaker, wherein an amplitude of the second modified audio signal is based on the input audio signal and the second distance filter.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable processors or gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method of generating sound in a system that includes a compact audio reproduction device, the computer-implemented method comprising:
determining a first distance between a first loudspeaker and the compact audio reproduction device;
determining a first corner frequency for a first distance filter based on the first distance;
generating a first modified audio signal for the first loudspeaker, wherein an amplitude of the first modified audio signal is based on an input audio signal and the first distance filter; and
transmitting the first modified audio signal to the first loudspeaker.

2. The computer-implemented method of claim 1, further comprising:
determining a second corner frequency for a second distance filter based on the first distance; and
generating a second modified audio signal for a second loudspeaker, wherein an amplitude of the second modified audio signal is based on the input audio signal and the second distance filter.

3. The computer-implemented method of claim 2, wherein the second loudspeaker is disposed within the compact audio reproduction device.

4. The computer-implemented method of claim 1, wherein the first loudspeaker is external to the compact audio reproduction device.

5. The computer-implemented method of claim 1, further comprising:
determining that the first distance between the first loudspeaker and the compact audio reproduction device has changed from a first distance value to a second distance value;
determining a second corner frequency for the first distance filter based on the second distance value of the first distance;
generating a second modified audio signal for the first loudspeaker, wherein an amplitude of the second modified audio signal is based on the input audio signal, the first distance filter, and the second corner frequency; and
transmitting the second modified audio signal to the first loudspeaker.

6. The computer-implemented method of claim 5, wherein, when the second distance value is greater than the first distance value, the second corner frequency is lower than the first corner frequency.

7. The computer-implemented method of claim 1, further comprising:
determining that the first distance between the first loudspeaker and the compact audio reproduction device exceeds a threshold distance value; and
transmitting no audio signal to the first loudspeaker.

8. The computer-implemented method of claim 1, further comprising:
determining that the first distance between the first loudspeaker and the compact audio reproduction device is less than a threshold distance value; and
transmitting no audio signal to a second loudspeaker that is disposed within the compact audio reproduction device.

9. The computer-implemented method of claim 1, wherein the compact audio reproduction device comprises a component of an interactive toy.

10. The computer-implemented method of claim 9, wherein the component comprises at least one of a modular component of the interactive toy or a removable component of the interactive toy.

11. The computer-implemented method of claim 1, wherein determining the first distance comprises tracking the first loudspeaker via one or more distance sensors.

12. The computer-implemented method of claim 11, wherein at least one of the one or more distance sensors is disposed within a compact audio reproduction device.

13. The computer-implemented method of claim 11, wherein at least one of the one or more distance sensors is disposed within the first loudspeaker.

14. One or more non-transitory computer-readable media storing instructions that, when executed by one or more processors, cause the one or more processors to perform the steps of:
determining a first distance between a first loudspeaker and a compact audio reproduction device;
determining a first corner frequency for a first distance filter based on the first distance;
generating a first modified audio signal for the first loudspeaker, wherein an amplitude of the first modified audio signal is based on an input audio signal and the first distance filter; and
transmitting the first modified audio signal to the first loudspeaker.

15. The non-transitory computer-readable media of claim 14, storing further instructions that, when executed by one or more processors, cause the one or more processors to perform the steps of:
determining a second corner frequency for a second distance filter based on the first distance; and
generating a second modified audio signal for a second loudspeaker, wherein an amplitude of the second modified audio signal is based on the input audio signal and the second distance filter.

16. The non-transitory computer-readable media of claim 14, storing further instructions that, when executed by one or more processors, cause the one or more processors to perform the steps of:
determining that the first distance between the first loudspeaker and the compact audio reproduction device has changed from a first distance value to a second distance value;
determining a second corner frequency for the first distance filter based on the second distance value of the first distance;
generating a second modified audio signal for the first loudspeaker, wherein an amplitude of the second modified audio signal is based on the input audio signal, the first distance filter, and the second corner frequency; and
transmitting the second modified audio signal to the first loudspeaker.

17. The non-transitory computer-readable media of claim 14, storing further instructions that, when executed by one or more processors, cause the one or more processors to perform the steps of:
determining a second distance between a second loudspeaker and the compact audio reproduction device;
determining a second corner frequency for a second distance filter based on the second distance;
generating a second modified audio signal for the second loudspeaker, wherein an amplitude of the second modified audio signal is based on the input audio signal and the second distance filter; and
transmitting the second modified audio signal to the second loudspeaker.

18. The non-transitory computer-readable media of claim 17, wherein transmitting the second modified audio signal to the second loudspeaker comprises halting the transmitting of the first modified audio signal to the first loudspeaker.

19. An interactive toy that generates an audio output, the interactive toy comprising:
at least one sensor that acquires sensor data;
an internal loudspeaker;
a memory storing instructions; and
one or more processors, that when executing the instructions, are configured to perform the steps of:
determining a first distance between a first satellite loudspeaker and the interactive toy;
determining a first corner frequency for a first distance filter based on the first distance;
generating a first modified audio signal for the first satellite loudspeaker, wherein an amplitude of the first modified audio signal is based on an input audio signal and the first distance filter; and
transmitting the first modified audio signal to the first satellite loudspeaker.

20. The interactive toy of claim 19, further comprising:
determining a second corner frequency for a second distance filter based on the first distance; and
generating a second modified audio signal for a second loudspeaker, wherein an amplitude of the second modified audio signal is based on the input audio signal and the second distance filter.
